(19) United States
(12) Patent Application Publication
(10) Pub. No.: US 2022/0171515 A1
(43) Pub. Date: Jun. 2, 2022

(54) TOUCH DISPLAY DEVICE AND CONTROLLER USED IN THE SAME

(71) Applicant: NOVATEK Microelectronics Corp., Hsin-Chu (TW)

(72) Inventors: Yu-Chung Lin, Taoyuan City (TW); He-Wei Huang, Hsinchu City (TW); Chun-Ching Huang, Hsinchu County (TW); Yao-Ren Fan, Hsinchu County (TW)

(73) Assignee: NOVATEK Microelectronics Corp., Hsin-Chu (TW)

(21) Appl. No.: 17/672,718

(22) Filed: Feb. 16, 2022

Related U.S. Application Data
(63) Continuation-in-part of application No. 16/357,556, filed on Mar. 19, 2019.
(60) Provisional application No. 62/713,016, filed on Aug. 1, 2018.

(51) Int. Cl. G06F 3/041

(52) U.S. Cl. CPC G06F 3/04162

(57) ABSTRACT

A controller of a touch display device is configured to perform steps of: transmitting a main uplink signal to an input device, the main uplink signal indicating an amount of a plurality of downlink signals transmitted in a frame; transmitting a first sub-uplink signal to the input device, the first sub-uplink signal notifying the input device of a time length of a first downlink signal among the plurality of downlink signals; transmitting a second sub-uplink signal to the input device, the second sub-uplink signal notifying the input device of a time length of a second downlink signal among the plurality of downlink signals; and receiving the plurality of downlink signals from the input device.

### CROSS REFERENCE TO RELATED APPLICATIONS

This application is a continuation-in-part application of U.S. application Ser. No. 16/357,556, filed on Mar. 19, 2019, which claims the benefit of U.S. Provisional Application No. 62/713,016, filed on Aug. 1, 2018. The contents of these applications are incorporated herein by reference.

### BACKGROUND OF THE INVENTION

### 1. Field of the Invention

The invention relates to a display device and a controller used in the display device.

### 2. Description of the Prior Art

Touch display devices are widely used in various electronic products such as smart phones, tablets and so on. Based on different sensing mechanisms, some touch display devices can support using an active pen as an input device in addition to fingers. To support an active pen, such touch display devices should be able to transmit uplink signals to the active pen and receive downlink signals from the active pen. However, since there may be an error between the clocks of the touch display device and the active pen, the timing of transmitting/receiving the uplink/downlink signals may be difficult to synchronize. Therefore, how to design a better signal transmission frame structure between the touch display device and the active pen is an important issue for improving the quality of touch display devices.

### SUMMARY OF THE INVENTION

It is therefore an objective of the present invention to provide a controller of a touch display device for controlling the interactions with the active pen, so as to solve the abovementioned problems.

An embodiment of the present invention discloses a controller of a touch display device. The controller is configured to perform steps of: transmitting a main uplink signal to an input device, the main uplink signal indicating an amount of a plurality of downlink signals transmitted in a frame; transmitting a first sub-uplink signal to the input device, the first sub-uplink signal notifying the input device of a time length of a first downlink signal among the plurality of downlink signals; transmitting a second sub-uplink signal to the input device, the second sub-uplink signal notifying the input device of a time length of a second downlink signal among the plurality of downlink signals; and receiving the plurality of downlink signals from the input device.

Another embodiment of the present invention discloses a touch display device, which comprises a display module, a touch module and a controller. The controller, coupled to the display module and the touch module, is configured to perform steps of: transmitting a main uplink signal to an input device, the main uplink signal indicating an amount of a plurality of downlink signals transmitted in a frame; transmitting a first sub-uplink signal to the input device, the first sub-uplink signal notifying the input device of a time length of a first downlink signal among the plurality of downlink signals; transmitting a second sub-uplink signal to the input device, the second sub-uplink signal notifying the input device of a time length of a second downlink signal among the plurality of downlink signals; and receiving the plurality of downlink signals from the input device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of a touch display device according to an embodiment of the present invention.

FIG. 2 shows a signal timing diagram of a touch display device according to an embodiment of the present invention.

FIGS. 3A and 3B show signal timing diagrams of a touch display device according to other embodiments of the present invention.

FIG. 4 shows a signal timing diagram of a touch display device according to yet another embodiment of the present invention.

FIG. 5 shows a signal timing diagram of a touch display device according to yet another embodiment of the present invention.

FIG. 6 shows a signal timing diagram of a touch display device according to yet another embodiment of the present invention.

FIG. 7 shows a signal timing diagram of a touch display device according to yet another embodiment of the present invention.

FIG. 8 is a flowchart of a process according to an embodiment of the present invention.

### DETAILED DESCRIPTION

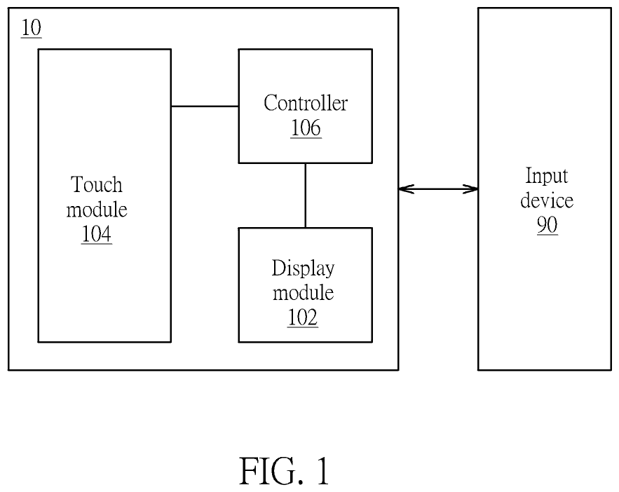

Referring to FIG. 1, FIG. 1 shows a block diagram of a touch display device 10 according to an embodiment of the present invention. The touch display device 10 includes a display module 102, a touch module 104 and a controller 106. The display module 102 may include a display panel for displaying. In an embodiment, the display panel may be a LCD/LED display panel, an OLED display panel and so on. The touch module 104 may include a touch panel for sensing touch signals from fingers and/or an input device 90. The controller 106 is coupled to the display module 102 and the touch module 104, and is configured to control the behavior of the display module 102 and the touch module 104. The controller 106 is further configured to transmit signals to the input device 90 to negotiate with the input device 90. In an embodiment, the input device 90 may be an active pen.

In this embodiment, signals from the input device 90 to the touch display device 10 are defined as downlink signals, and signals from the touch display device 10 to the input device 90 are defined as uplink signals.

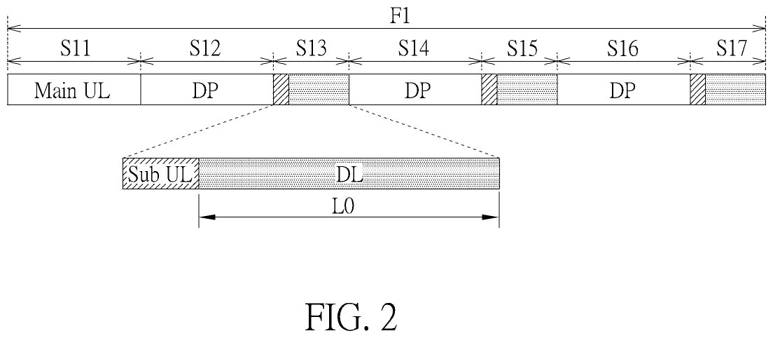

Referring to FIG. 2, FIG. 2 shows a signal timing diagram of a touch display device according to an embodiment of the present invention. This timing diagram shows the signal timing of the touch display device 10. A frame F1 includes a number of time slots S11˜S17. In the time slot S11, “Main UL” refers to a main uplink signal transmitted from the controller 106 of the touch display device 10 to the input device 90. The main uplink signal may include the time length of a downlink signal and the amount of the downlink signal(s) that the input device 90 is required to transmit in the frame F1. For example, the main uplink signal may indicate that the time length of the downlink signal transmitted in the time slot S13 equals L0, and also indicate that there are totally 3 downlink signals to be transmitted in the frame F1 (i.e., in the time slots S13, S15 and S17 in this example).

Note that a frame such as F1 indicates a time length in which an image frame is displayed or a frame of image data is output to the display panel of the touch display device 10. In general, the length of a frame may be determined based on the frame rate (or called refresh rate) of the display panel. For example, the length of the frame may equal 16.66 ms if the frame rate is 60 Hz, or may equal 8.33 ms if the frame rate is 120 Hz.

In another embodiment, the main uplink signal may further include a preamble that allows the input device 90 to find the touch display device 10, connection information for the input device 90 to establish a connection with the touch display device 10, a modulation type and a frequency used by the input device 90 to transmit downlink signals, a selection indication for selecting a mode from various modes of the input device 90, error correcting codes (ECC) such as cyclic redundancy check (CRC) code and/or any information if needed.

In the time slots S12, S14 and S16, “DP” refers to a display term of the touch display device 10. During the display term, the controller 106 of the touch display device 10 may enable the display module 102 to output display signals and may disable the touch module 104. That is, during the display term, the controller 106 may not transmit uplink signals to the input device 90 and receive downlink signals from the input device 90.

In the time slots S13, S15 and S17, “sub UL” refers to a sub-uplink signal transmitted from the controller 106 to the input device 90. The sub-uplink signal is configured to notify the input device 90 of the timing at which the corresponding downlink signal may be transmitted. In an embodiment, the sub-uplink signal may be a signal with a fixed frequency and free of including any information. In another embodiment, the sub-uplink signal may include a device ID of the input device 90 (if there is one or more other input devices), a selection indication for selecting a mode from various modes of the input device 90, ECC such as CRC code, a requirement for the content of the downlink signal (e.g., re-transmission of a previous downlink signal) and/or any information if needed. “DL” refers to a downlink signal transmitted from the input device 90 to the controller 106. The input device 90 may transmit a downlink signal only when said sub-uplink signal is received. That is, in this embodiment, after a main uplink signal has been transmitted from the controller 106 to the input device 90, the controller 106 is configured to transmit one or more sub-uplink signals to the input device 90 to cause the input device 90 to transmit one or more downlink signals to the touch display device 10 in response to each of the one or more sub-uplink signals. More specifically, in this embodiment, a time slot includes one sub-uplink signal and one downlink signal, and one downlink signal is corresponding to one sub-uplink signal.

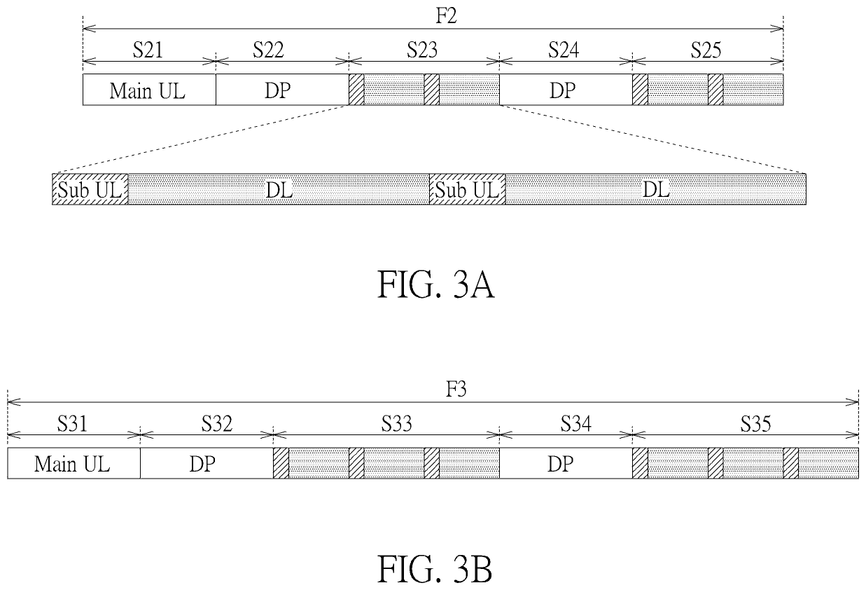

Referring to FIGS. 3A and 3B, FIGS. 3A and 3B show signal timing diagrams of a touch display device according to other embodiments of the present invention. In FIG. 3A, a frame F2 includes a number of time slots S21˜S25. Each of the time slots S23 and S25 may include two sub-uplink signals and two downlink signals, and the downlink signals are corresponding to the sub-uplink signals, respectively. In FIG. 3B, a frame F3 includes a number of time slots S31˜S35. Each of the time slots S33 and S35 may include three sub-uplink signals and three downlink signals, and the downlink signals are corresponding to the sub-uplink signals, respectively. That is, the controller 106 may transmit two or more sub-uplink signals in a single time slot, and the input device 90 may transmit a downlink signal in response to each of the sub-uplink signals. In an embodiment, the amount of the sub-uplink signals to be transmitted in a single time slot may be defined in the main uplink signal. In this case, the main uplink signal may include the information of the amount of the sub-uplink signals to be transmitted in a single time slot. When the input device 90 receives the main uplink signal from the controller 106, the input device 90 may know the amount of downlink signal (s) to be transmitted in a single time slot in response to the sub-uplink signals.

Referring to FIG. 4, FIG. 4 shows a signal timing diagram of a touch display device according to yet another embodiment of the present invention. In FIG. 4, a frame F4 includes a number of time slots S41˜S49. Each of the time slots S43 and S47 includes one sub-uplink signal and one downlink signal. Each of the time slots S45 and S49 includes one downlink signal without any sub-uplink signal. In this embodiment, the controller 106 transmits a sub-uplink signal in the time slot S43, and the input device 90 transmits two downlink signals in the time slots S43 and S45, respectively, in response to the sub-uplink signal in the time slot S43. The controller 106 transmits a sub-uplink signal in the time slot S47, and the input device 90 transmits two downlink signals in the time slots S47 and S49, respectively, in response to the sub-uplink signal in the time slot S47. That is, two downlink signals in two different time slots are corresponding to one sub-uplink signal. In this case, the amount of time slots for downlink signal corresponding to a single sub-uplink signal may be defined in the main uplink signal by the controller 106. According to the received main uplink signal, the input device 90 may transmit the downlink signals in the designated number of time slots in response to a single sub-uplink signal.

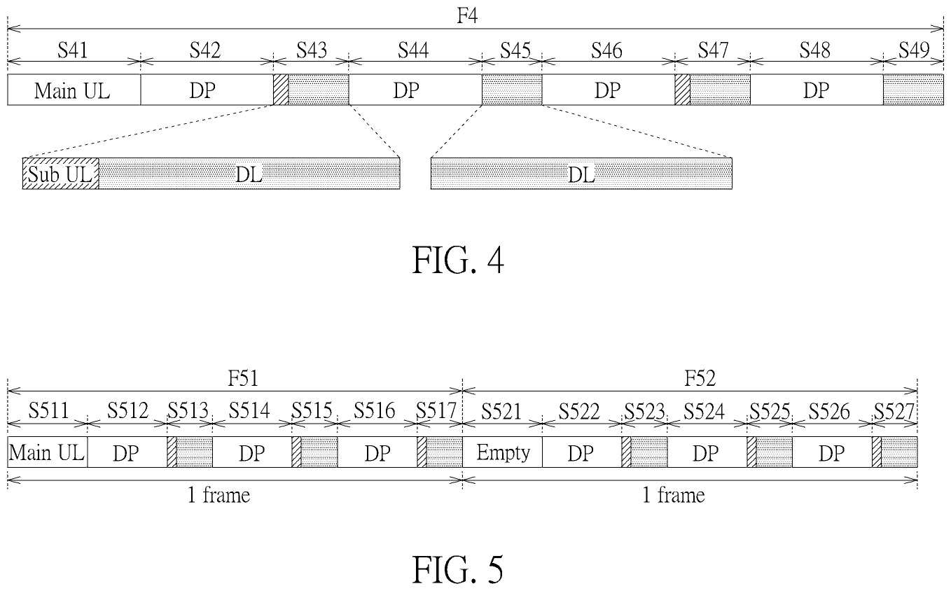

Referring to FIG. 5, FIG. 5 shows a signal timing diagram of a touch display device according to yet another embodiment of the present invention. In FIG. 5, a frame F51 includes a number of time slots S511˜S517, and a frame F52 includes a number of time slots S521˜S527. In this embodiment, the sub-uplink signals and the downlink signals in two or more frames are corresponding to a single main uplink signal. In this case, the amount of frames corresponding to a single main uplink signal may be defined in the main uplink signal by the controller 106.

Note that the main uplink signal and the sub-uplink signal may be transmitted by any modulation and any frequency. Furthermore, the length of the main uplink signal and the sub-uplink signal may be determined according to actual needs.

In addition, the input device 90 may be configured to be reset when no sub-uplink signal is received in several consecutive frames after a main uplink signal is received. When the input device 90 is reset, the controller 106 may be required to transmit another main uplink signal to activate the input device 90 to be ready for transmitting downlink signals.

With the sub-uplink signal, the input device 90 may know a specific time for transmitting the downlink signal without relying on accurate clock synchronization with the touch display device 10.

Please note that the present invention aims at providing a method for a controller of a touch display device, to control the interactions with an active pen. Those skilled in the art may make modifications and alterations accordingly. For example, in the above embodiments, various information and commands are carried in the main uplink signal. In another embodiment, some or all of the information and commands that need to be delivered to the input device 90 may be carried in the sub-uplink signals.

Referring to FIG. 6, FIG. 6 shows a signal timing diagram of a touch display device according to yet another embodiment of the present invention. In FIG. 6, a frame F6 includes a number of time slots S61˜S67. Each of the time slots S63, S65 and S67 includes one sub-uplink signal and one downlink signal. In this embodiment, the controller 106 may transmit a main uplink signal to the input device 90 in the time slot S61, where the main uplink signal indicates the amount of the downlink signals transmitted in the frame F6, i.e., 3. The controller 106 then transmits sub-uplink signals to the input device 90 in the time slots S63, S65 and S67, and the input device 90 transmits downlink signals in response to the corresponding sub-uplink signals, respectively.

In this embodiment, the sub-uplink signals may notify the input device 90 of the time length of the corresponding downlink signals. More specifically, the sub-uplink signal transmitted in the time slot S63 indicates that the corresponding downlink signal transmitted in the time slot S63 has the time length equal to L1; and the sub-uplink signal transmitted in the time slot S65 indicates that the corresponding downlink signal transmitted in the time slot S65 has the time length equal to L2. It is preferable to use the sub-uplink signal to carry the information of respective time length of the downlink signal if these downlink signals have different lengths. For example, as shown in FIG. 6, the sub-uplink signals may have a time length field that carries the time length information. The sub-uplink signal transmitted in the time slot S63 has a code value 0x01 in its time length field, which indicates that the time length of the following downlink signal is 100 μs (i.e., L1=100 μs). The sub-uplink signal transmitted in the time slot S65 has a code value 0x02 in its time length field, which indicates that the time length of the following downlink signal is 150 μs (i.e., L2=150 μs). The code values should be recognizable by the input device 90 based on the specification of the input device 90 and/or previous negotiation between the input device 90 and the touch display device 10. In such a situation, the time lengths of the downlink signals transmitted in the time slots S63 and S65 may be different, and the input device 90 may transmit the downlink signals based on the corresponding time length information.

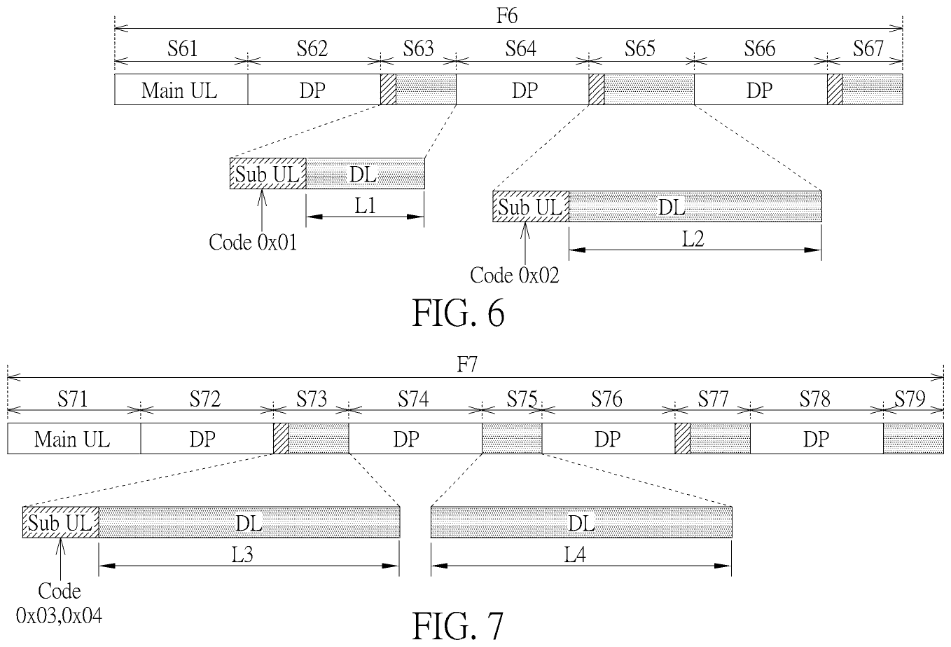

Referring to FIG. 7, FIG. 7 shows a signal timing diagram of a touch display device according to yet another embodiment of the present invention. In FIG. 7, a frame F7 includes a number of time slots S71˜S79. Each of the time slots S73 and S77 includes one sub-uplink signal and one downlink signal. Each of the time slots S75 and S79 includes one downlink signal without any sub-uplink signal. In this embodiment, the input device 90 transmits two downlinks signals in the time slots S73 and S75, respectively, in response to the sub-uplink signal received in the time slot S73, and transmits two downlinks signals in the time slots S77 and S79, respectively, in response to the sub-uplink signal received in the time slot S77. Therefore, the sub-uplink signal transmitted in the time slot S73 may carry the time length information of the downlink signals in the time slots S73 and S75, and the sub-uplink signal transmitted in the time slot S77 may carry the time length information of the downlink signals in the time slots S77 and S79.

For example, as shown in FIG. 7, the sub-uplink signal transmitted in the time slot S73 has code values 0x03 and 0x04 in its time length field. The code value 0x03 indicates the value of the time length L3 of the downlink signal in the time slot S73, and the code value 0x04 indicates the value of the time length L4 of the downlink signal in the time slot S75.

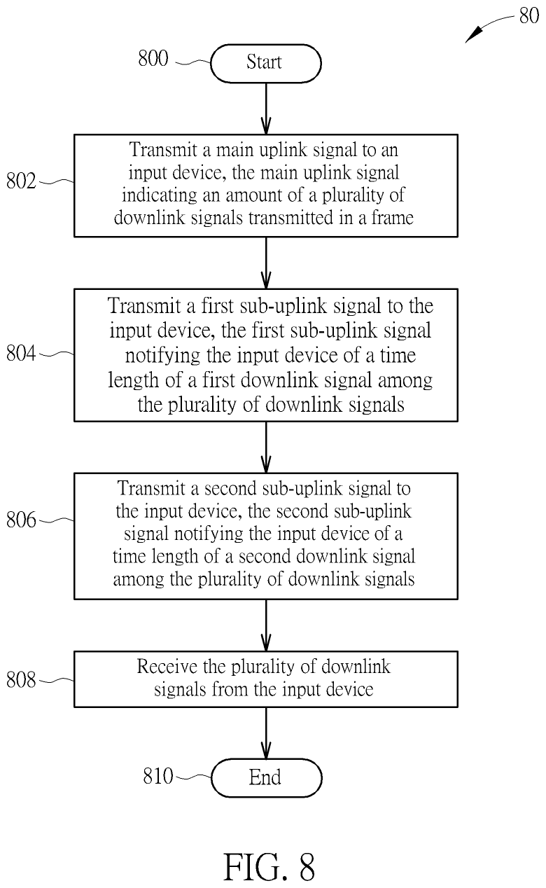

The above operations of the touch display device may be summarized into a process 80, as shown in FIG. 8. The process 80, which may be implemented in a controller of a touch display device such as the controller 106 of the touch display device 10 shown in FIG. 1, includes the following steps:

Step 800: Start.

Step 802: Transmit a main uplink signal to an input device, the main uplink signal indicating an amount of a plurality of downlink signals transmitted in a frame.

Step 804: Transmit a first sub-uplink signal to the input device, the first sub-uplink signal notifying the input device of a time length of a first downlink signal among the plurality of downlink signals.

Step 806: Transmit a second sub-uplink signal to the input device, the second sub-uplink signal notifying the input device of a time length of a second downlink signal among the plurality of downlink signals.

Step 808: Receive the plurality of downlink signals from the input device.

Step 810: End.

The detailed operations and alterations of the process 80 are illustrated in the above paragraphs, and will not be narrated herein.

To sum up, the present invention provides a controller of a touch display device and a method used by the touch display device for interacting with an active pen. The controller may transmit a main uplink signal and several sub-uplink signals to an input device such as the active pen. In an embodiment, both the main uplink signal and the sub-uplink signals may carry information and/or commands to be sent to the input device. For example, the main uplink signal may indicate the amount of downlink signals to be transmitted in a frame, and each sub-uplink signal may notify the input device of the time length of the downlink signal(s) corresponding to the sub-uplink signal. As a result, the input device may transmit the downlink signals in an appropriate manner, to be adaptive to the timing allocation of the touch display device under well synchronization between the input device and the touch display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller of a touch display device, configured to perform:
transmitting a main uplink signal to an input device, the main uplink signal indicating an amount of a plurality of downlink signals transmitted in a frame;
transmitting a first sub-uplink signal to the input device, the first sub-uplink signal notifying the input device of a time length of a first downlink signal among the plurality of downlink signals;
transmitting a second sub-uplink signal to the input device, the second sub-uplink signal notifying the input device of a time length of a second downlink signal among the plurality of downlink signals; and
receiving the plurality of downlink signals from the input device.

2. The controller of claim 1, wherein the first sub-uplink signal is transmitted in a first time slot in which the first downlink signal is to be received, and the second sub-uplink signal is transmitted in a second time slot in which the second downlink signal is to be received, wherein the first time slot is different from the second time slot.

3. The controller of claim 1, wherein the time length of the first downlink signal is different from the time length of the second downlink signal.

4. The controller of claim 1, wherein the first downlink signal is received in response to the first sub-uplink signal, and the second downlink signal is received in response to the second sub-uplink signal.

5. The controller of claim 1, wherein the first sub-uplink signal further notifies the input device of a time length of a third downlink signal among the plurality of downlink signals, and the first downlink signal and the third downlink signal are received in different time slots.

6. A touch display device, comprising:
a display module;
a touch module; and
a controller, coupled to the display module and the touch module, and configured to perform:
transmitting a main uplink signal to an input device, the main uplink signal indicating an amount of a plurality of downlink signals transmitted in a frame;
transmitting a first sub-uplink signal to the input device, the first sub-uplink signal notifying the input device of a time length of a first downlink signal among the plurality of downlink signals;
transmitting a second sub-uplink signal to the input device, the second sub-uplink signal notifying the input device of a time length of a second downlink signal among the plurality of downlink signals; and
receiving the plurality of downlink signals from the input device.

7. The touch display device of claim 6, wherein the first sub-uplink signal is transmitted in a first time slot in which the first downlink signal is to be received by the controller, and the second sub-uplink signal is transmitted in a second time slot in which the second downlink signal is to be received by the controller, wherein the first time slot is different from the second time slot.

8. The touch display device of claim 6, wherein the time length of the first downlink signal is different from the time length of the second downlink signal.

9. The touch display device of claim 6, wherein the first downlink signal is received by the controller in response to the first sub-uplink signal, and the second downlink signal is received by the controller in response to the second sub-uplink signal.

10. The touch display device of claim 6, wherein the first sub-uplink signal further notifies the input device of a time length of a third downlink signal among the plurality of downlink signals, and the first downlink signal and the third downlink signal are received by the controller in different time slots.
